(19) United States
(12) Patent Application Publication
(10) Pub. No.: US 2025/0223242 A1
(43) Pub. Date: Jul. 10, 2025

(54) ADDITIVELY MANUFACTURED HYBRID ROCKET ENGINE FUEL GRAINS CONTAINING SOLID PROPELLANT MATERIAL

(71) Applicant: Firehawk Aerospace, Inc., Addison, TX (US)

(72) Inventors: Michael Joseph Baier, Garland, TX (US); Justin Otto Karl, Titusville, FL (US); Andrew Copeland, Plano, TX (US); Ben Giles, Carrollton, TX (US)

(21) Appl. No.: 19/013,794

(22) Filed: Jan. 8, 2025

Related U.S. Application Data
(60) Provisional application No. 63/619,232, filed on Jan. 9, 2024.

(51) Int. Cl. C06B 45/12; F02K 9/10

(52) U.S. Cl. CPC C06B 45/12; F02K 9/10

(57) ABSTRACT

A fuel grain assembly for a hybrid rocket engine includes a hybrid fuel grain including fuel grain material, wherein an outermost portion of the fuel grain material defines an outer surface of the fuel grain, and wherein the fuel grain material includes a polymer based rocket fuel material; and a solid propellant material disposed in contact with the fuel grain material of the hybrid fuel grain, wherein the solid propellant material includes an oxidizer and a binder material, wherein a hollow combustion port extends through the fuel grain assembly, wherein at least a portion of a wall of the hollow combustion port is defined by the solid propellant material.

### CLAIM OF PRIORITY

This application claims priority under 35 USC § 119(e) to U.S. Patent Application Ser. No. 63/619,232, filed on Jan. 9, 2024, the entire contents of which are hereby incorporated by reference.

### BACKGROUND

There are various types of chemical rocket propulsion systems. Liquid rocket engines use liquid-phase propellants. Solid rocket motors use solid-phase propellants. Hybrid rocket engines use a combination of liquid and solid-phase propellant constituents. In a hybrid rocket engine, oxidizer is typically in liquid or vapor state and fuel is in solid or semi-solid state. The fuel is formed into a tubular shaped fuel grain with one or more ports that serve via pyrolization as the fuel source and as the engine's combustion chamber(s).

### SUMMARY

We described here hybrid rocket engine fuel grains that are formed of combustible fuel grain material (e.g., polymer fuel material, optionally with micro- or nano-scale metallic additives). A combustion port is defined through the length of the fuel grain. An oxidizer flows through the combustion port during operation of the hybrid rocket engine, causing combustion of the fuel grain material that is exposed to the combustion port. Combustion of newly exposed fuel grain material continues during the operation of the hybrid rocket engine, e.g., until oxidizer flow is terminated or until the fuel grain is exhausted. To aid with ignition of the fuel grain material at the beginning of operation, a fuel grain assembly is formed that includes a solid propellant material disposed on the inner surface of the fuel grain. The presence of the solid propellant material aids in heating and ignition of the fuel grain material, enabling a faster response (e.g., enabling rapid thrust to be provided) as compared to fuel grains without solid propellant material. Because the solid propellant material is provided in only a thin layer (e.g., a few millimeters in thickness), combustion rapidly reaches the fuel grain material, allowing the fuel grain material to provide power for the large majority of the operation.

In an aspect, a fuel grain assembly for a hybrid rocket engine includes a hybrid fuel grain including fuel grain material, wherein an outermost portion of the fuel grain material defines an outer surface of the fuel grain, and wherein the fuel grain material includes a polymer based rocket fuel material; and a solid propellant material disposed in contact with the fuel grain material of the hybrid fuel grain, wherein the solid propellant material includes an oxidizer and a binder material, wherein a hollow combustion port extends through the fuel grain assembly, wherein at least a portion of a wall of the hollow combustion port is defined by the solid propellant material.

Embodiments can include one or any combination of two or more of the following features.

The hybrid fuel grain includes multiple layers of fuel grain material, and wherein the outermost portion of the fuel grain material defining the outer surface of the fuel grain includes an outermost layer of the fuel grain material. In some cases, the solid propellant material is disposed on an innermost layer of the hybrid fuel grain. In some cases, the solid propellant material is disposed between two layers of fuel grain material of the hybrid fuel grain. In some cases, each layer of fuel grain material includes beads of the fuel grain material.

The solid propellant material is a continuous layer of the solid propellant material.

The solid propellant material defines the entirety of the wall of the hollow combustion port.

The solid propellant material is disposed on less than all of an innermost surface of the fuel grain, and wherein the wall of the combustion port is defined by the solid propellant material and by portions of the innermost surface of the fuel grain. In some cases, the solid propellant material is disposed is adjacent an inlet end of the combustion port.

A thickness of the solid propellant material is non-uniform.

A thickness of the solid propellant material varies monotonically along the axis of the combustion port. In some cases, the thickness of the solid propellant material is greatest toward an inlet end of the combustion port.

A surface roughness of the solid propellant material is non-uniform. In some cases, the solid propellant material includes a first region having a first surface roughness and a second region having a second surface roughness less than the first surface roughness. In some cases, the first region is disposed closer to an inlet end of the combustion port than the second region.

The solid propellant material includes an inner layer and an outer layer, wherein the inner layer is exposed to the combustion port, and wherein the inner layer has a more energetic composition than the outer layer. In some cases, the inner layer includes solid propellant material and an energetic additive.

The solid propellant layer is doped with a material that is catalytic with an oxidizer.

The binder material includes a thermoset or thermoplastic binder material.

The binder material includes a sugar based material.

The binder material includes a solid fuel additive.

The solid propellant material has an ignition temperature that is higher than a temperature used during deposition of the solid propellant material.

The solid propellant material includes an additive. In some cases, the additive includes a metallic fuel additive. In some cases, the additive has a decomposition temperature that is higher than a forming temperature of the solid propellant material. In some cases, the solid propellant material containing the additive has an ignition temperature that is higher than a forming temperature of the solid propellant material.

The solid propellant material is deposited by casting.

The solid propellant material is deposited by additive manufacturing.

The fuel grain material includes a nano-scale or micron-scale additive.

The fuel grain material includes an additive including a metal or metal hydride.

In an aspect, a method of making a fuel grain assembly includes using an additive manufacturing tool, disposing a solid propellant material to form a layer of solid propellant material, wherein the solid propellant material includes an oxidizer and a binder material; and using the additive manufacturing tool, disposing fuel grain material in contact with the solid propellant material to form a fuel grain including layers of the fuel grain material, wherein the fuel grain material includes a polymer based rocket fuel material, wherein the solid propellant material defines at least a portion of a wall of a hollow combustion port extending through the fuel grain.

Embodiments can include one or any combination of two or more of the following features.

The method includes disposing the solid propellant material onto a mandrel.

The method includes disposing the solid propellant material and the fuel grain material such that the wall of the combustion port is defined in part by the solid propellant material and in part by the second portion of the fuel grain material.

The method includes disposing the solid propellant material at a temperature that is lower than an ignition temperature of the solid propellant material.

The method includes disposing the solid propellant material in different thicknesses at different locations.

Disposing the solid propellant material includes: disposing an inner layer of solid propellant material; and disposing an outer layer of solid propellant material onto the inner layer, wherein the inner layer has a more energetic composition than the outer layer, and wherein the fuel grain material is disposed onto the outer layer.

The method includes disposing the solid propellant material at a temperature that is less than a temperature of an ignition temperature of the solid propellant material.

The method includes disposing the fuel grain material at a temperature that is less than a temperature of an ignition temperature of the solid propellant material.

In an aspect, method of making a fuel grain assembly includes using an additive manufacturing tool, disposing beads of fuel grain material to form a hybrid fuel grain including layers of fuel grain material with a hollow combustion port extending therethrough, wherein the fuel grain material includes a polymer based rocket fuel material; and disposing a solid propellant material in contact with an innermost layer of the hybrid fuel grain such that at least a portion of a wall of the hollow combustion port is defined by the solid propellant material, wherein the solid propellant material includes an oxidizer and a binder material.

Embodiments can include one or any combination of two or more of the following features.

Disposing the solid propellant material includes casting the solid propellant material onto the innermost layer of the hybrid fuel grain.

Disposing the solid propellant material includes disposing a precursor formulation onto the innermost layer of the hybrid fuel grain and curing the precursor formulation to form the solid propellant material.

The method includes disposing the solid propellant material at a temperature that is lower than an ignition temperature of the solid propellant material.

The method includes disposing the solid propellant material using additive manufacturing.

Depositing the solid propellant material includes:
disposing a slurry containing the solid propellant material and a solvent onto the innermost layer of the fuel grain material; and drying the slurry. In some cases, the slurry partially dissolves the fuel grain material.

The method includes inserting a mandrel into the combustion port defined by the fuel grain material, and wherein disposing the solid propellant material includes providing the solid propellant material into a space between the mandrel and the innermost layer of fuel grain material.

In an aspect, a method of making a fuel grain assembly for a hybrid rocket engine includes forming a hybrid fuel grain including fuel grain material, wherein an outermost portion of the fuel grain material defines an outer surface of the fuel grain, and wherein the fuel grain material includes a polymer based rocket fuel material; and disposing a solid propellant material in contact with the fuel grain material of the hybrid fuel grain, wherein the solid propellant material includes an oxidizer and a binder material, wherein a hollow combustion port extends through the fuel grain assembly, wherein at least a portion of a wall of the hollow combustion port is defined by the solid propellant material.

Embodiments can include one or any combination of two or more of the following features.

The method includes forming the hybrid fuel grain by additive manufacturing.

The method includes forming the hybrid fuel grain by casting.

The method includes disposing the solid propellant material by additive manufacturing.

The method includes disposing the solid propellant material by casting.

The details of one or more implementations are set forth in the accompanying drawings and the description below. Other features and advantages will be apparent from the description and drawings, and from the claims.

### BRIEF DESCRIPTION OF DRAWINGS

FIGS. 1A and 1B are perspective and cross-sectional views, respectively, of a fuel grain assembly.

FIGS. 2A and 2B are cross-sectional views of a fuel grain assembly.

FIGS. 3 and 4 are cross-sectional views of fuel grain assemblies.

FIG. 5 is a cross-sectional view of a fuel grain assembly.

FIGS. 6A-6C are schematic diagrams of operation of a fuel grain assembly.

FIGS. 7A and 7B are cross-sectional diagrams of methods of manufacturing fuel grain assemblies.

FIGS. 8A and 8B are cross-sectional diagrams of a method of manufacturing a fuel grain assembly.

FIG. 9 is a diagram of a fuel grain set.

FIG. 10 is a diagram of a hybrid rocket engine powered vehicle.

### DETAILED DESCRIPTION

Hybrid rocket engine fuel grains are formed of combustible fuel grain material (e.g., polymer fuel material, optionally with micro-or nano-scale metallic additives). A combustion port is defined through the length of the fuel grain. An oxidizer flows through the combustion port during operation of the hybrid rocket engine, causing combustion of the fuel grain material that is exposed to the combustion port. Combustion of newly exposed fuel grain material continues during the operation of the hybrid rocket engine, e.g., until oxidizer flow is terminated or until the fuel grain is exhausted. To aid with ignition of the fuel grain material at the beginning of operation, a fuel grain assembly is formed that includes a solid propellant material disposed on the inner surface of the hybrid fuel grain. The presence of the solid propellant material aids in heating and ignition of the fuel grain material, enabling a faster response (e.g., enabling rapid thrust to be provided) as compared to fuel grains without solid propellant material. Because the solid propellant material is provided in only a thin layer (e.g., a few millimeters in thickness), combustion rapidly reaches the fuel grain material, allowing the fuel grain material to provide power for the large majority of the operation.

A fuel grain assembly is a hybrid fuel grain formed of fuel grain material, and further including a small amount of solid propellant material, e.g., disposed on an inner surface of the hybrid fuel grain. Fuel grain assemblies having a small amount of solid propellant material to aid with ignition of the fuel grain material advantageously enables hybrid rocket engines to perform comparably to solid rocket motors during initial startup transients. For instance, the fast action of the solid propellant material rapidly provides heat to the fuel grain material and enables a rapid increase in engine pressure, which shortens the transient startup period of the hybrid rocket engine. In some examples, the solid propellant material in an otherwise hybrid rocket engine can produce sufficient thrust to initially accelerate a vehicle or other movable device while the system transitions into hybrid operation.

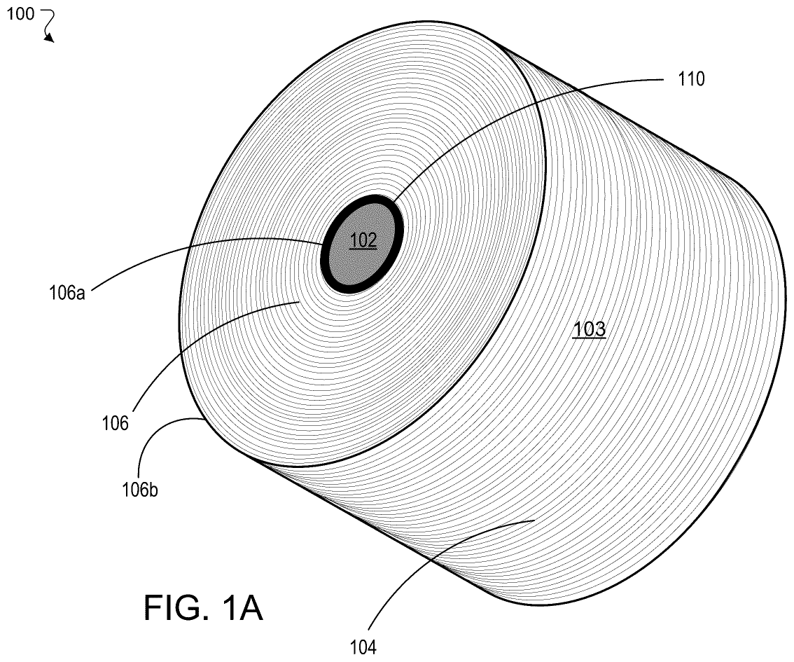

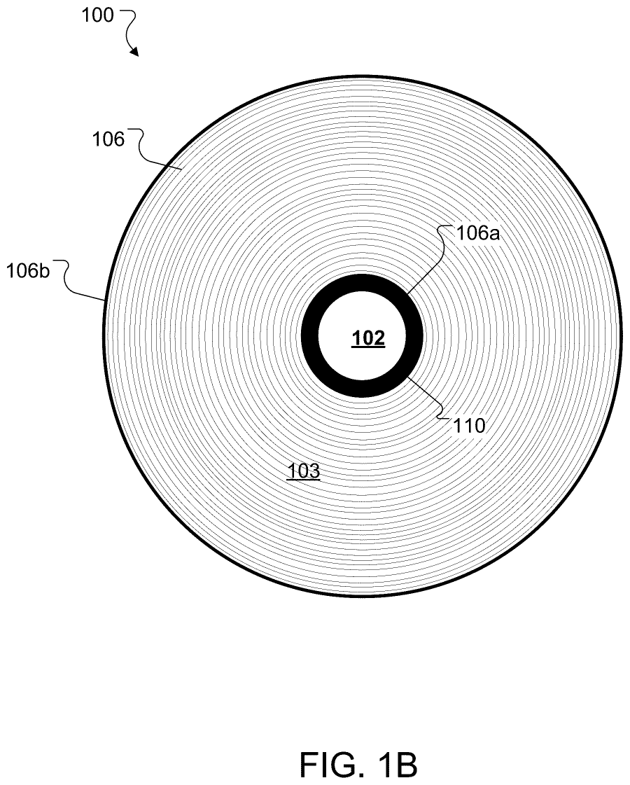

FIGS. 1A and 1B show a perspective view and a cross-sectional view, respectively, of an example fuel grain assembly 100 for a hybrid rocket engine. In the cross-sectional view of FIG. 1B, the axis of the fuel grain assembly 100 is oriented into the page of the figure. The fuel grain assembly 100 as illustrated has a generally cylindrical shape, e.g., an elongated tubular shape with a substantially circular cross section. A hollow combustion port 102 is defined in the interior of the fuel grain assembly 100, e.g., centered within the fuel grain assembly, and extends axially along the length of the fuel grain assembly 100. The combustion port 102 has a substantially circular cross section. Although the fuel grain assembly 100 is illustrated as being cylindrical and with a substantially cylindrical combustion port, other shapes of fuel grain assemblies and combustion ports are also within the scope of this disclosure. For instance, fuel grain assemblies can be elongated, non-cylindrical structures, disc-shaped structures, or other suitable shapes. Additionally, fuel grain assemblies can have various shapes of combustion ports, and can have one or multiple combustion ports. For instance, the combustion ports are not necessarily parallel to a central axis of the fuel grain assembly, e.g., a combustion port can be a helical port that revolves about a central axis along the length of the fuel grain assembly.

As illustrated, the fuel grain assembly 100 is formed from concentric beads 104 of fuel grain material that are bonded (e.g., fused) to one another to form a hybrid fuel grain 103. Each concentric bead 104 has a generally ring-shaped, circular structure, with a substantially circular length of material and a substantially circular opening defined within the circular length of material. The radius of a concentric bead of a cylindrical fuel grain is the radius of the cylinder at the position of that bead. A given bead 104 is fused at its outer edge (e.g., in the direction of the radius of the fuel grain 100) to a concentric bead of a larger radius and at its inner edge to a concentric bead of a smaller radius, thereby forming radially oriented layers of beads.

Each concentric bead 104 is also fused along the axis of the fuel grain 103 to other concentric beads of substantially the same radius. Concentric beads that are fused along the axial direction are not concentric with one another, but are concentric with other concentric beads in the radial direction. The multiple concentric beads of substantially the same radius that are fused together along the axial direction of the fuel grain 103 constitute an axially oriented layer 106 of the fuel grain. The concentric beads 104 are thus arranged into concentric, substantially cylindrical layers 106 with substantially circular cross section, with an outermost layer 106b forming an outer wall of the fuel grain 103. Other shapes of beads are also possible, e.g., depending on the desired shape of the solid propellant grain and/or the configuration of the additive manufacturing tool (e.g., the geometry of the extruder nozzle).

In some examples, the fuel grain material in fuel grain assemblies has configurations other than the layered configuration illustrated in FIG. 1. For instance, fuel grains can be formed by casting fuel grain material into suitable shapes.

A fuel grain material generally refers to a solid, combustible fuel material for use in a hybrid rocket engine. Generally, a fuel grain material is a material that does not sustain combustion on its own, but is combustible in the presence of a separate oxidizer to thereby allow the fuel grain material and oxidizer to serve as a propellant. Example fuel grain materials include a polymer based rocket fuel material, e.g., such as acrylonitrile butadiene styrene (ABS) thermoplastic or another polymer based rocket fuel material having desired combustion properties. Example fuel grain materials can also include micron-scale or nanoscale additives, such as micron-scale or nanoscale metal particles (e.g., aluminum or magnesium particles), micron-scale or nanoscale metal hydride particles, micron-scale or nanoscale polymer particles, or other suitable additives. In some examples, the micron-scale or nanoscale metallic particles are passivated with a polymer coating. In some examples, the micron-scale or nanoscale metallic particles have an oxide shell (e.g., aluminum particles can have an aluminum oxide shell). The additive particles can be of any suitable geometry, e.g., spheres, flakes, ellipses, or other geometries. In some examples, fuel grain materials do not contain an oxidizer. In some examples, the fuel grain material contains an additive that is an oxidizer, e.g., in small enough quantities that the oxidizer content in the fuel grain material is insufficient to sustain combustion that produces thrust.

When the fuel grain material includes micron-scale additives (e.g., micron-scale metallic, metal hydride, or polymer particles, or particles of another composition), the micron-scale particles have an average dimension (e.g., diameter) of between 1 μm and 1000 μm, e.g., between 1 μm and 500 μm or between 1 μm and 100 μm, e.g., 1 μm, 10 μm, 25 μm, 50 μm, 100 μm, 250 μm, 500 μm, or 1000 μm. When the fuel grain material includes nanoscale additives (e.g., nanoscale metallic, metal hydride, or polymer particles, or particles of another composition), the nanoscale particles have an average dimension (e.g., diameter) of less than 1 μm, e.g., 500 nm or less, or 100 nm or less, e.g., 500 nm, 400 nm, 300 nm, 200 nm, 100 nm, 50 nm, 20 nm, 10 nm or another diameter. Generally, the fuel grain material is composed of between about 75% and 95% by weight of the hybrid rocket fuel material and between about 5% and 25% by weight of the micron-scale or nanoscale additive. In some examples, higher concentrations of additives can be present in the fuel grain material.

A solid propellant material 110 is disposed on an innermost layer 106a of the fuel grain 103 to form the fuel grain assembly 100, with the solid propellant material 110 forming at least a portion of a wall of the combustion port 102. In some examples, the solid propellant material 110 is a continuous layer that forms the entirety of the wall of the combustion port 102. In some examples, the solid propellant material 110 is disposed on only a portion of the innermost layer 106a of the fuel grain material such that the solid propellant material 110 and the uncovered portions of the innermost layer 106a of the fuel grain 103 together form the wall of the combustion port 102. In some examples, solid propellant material 110 is disposed between layers of fuel grain material (as discussed below) or on the outermost layer 106b of the fuel grain material.

In some cases, the thickness of the solid propellant material 110 is significantly less than the thickness of the fuel grain assembly 100, e.g., the thickness of the solid propellant material 110 can be less than or equal to about 10%, 5%, 2%, 1%, 0.5%, or 0.1% of a maximum radial thickness of the fuel grain assembly. In some cases, the thickness of the solid propellant material 110 is greater than 10% of the maximum radial thickness of the fuel grain assembly 100. The thickness of the solid propellant material 110 is selected depending on the design objective. For instance, a relatively thin solid propellant material ignites easily and burns quickly to rapidly preheat the innermost section of the fuel grain prior to the initiation of oxidizer flow through the combustion port 102. Alternatively, a relatively thicker solid propellant section can produce a reasonable duration of useful thrust.

A solid propellant material generally refers to a solid, combustible material that is composed of a mixture of fuel and oxidizer constituents provided in relative amounts such that the mixture is capable of sustaining combustion, e.g., for a solid rocket motor. Solid propellant materials include a solid oxidizer and a solid fuel material. In some examples, the solid propellant materials include a solid fuel additive and a separate binder material. In some examples, the solid propellant materials include a binder material that serves as a primary fuel material such that the solid propellant material does not include a solid fuel additive. In some examples, the solid propellant materials include a solid oxidizer, a solid fuel additive, and a binder material that serves as a supplemental lower energy density fuel. In some examples, the solid propellant material also includes additional additives.

The oxidizers for solid propellant materials used in the fuel grain assemblies described here can be solid oxidizers that are commonly used in conventional solid propellant formulations, e.g., potassium nitrate, potassium perchlorate, ammonium nitrate, ammonium perchlorate, sodium perchlorate, or other suitable oxidizers. When additive manufacturing is used to form the solid propellant material (discussed further below), the oxidizers are materials that are compatible with additive manufacturing processes, e.g., oxidizers that are thermally stable at the temperatures used during additive manufacturing processes, resistant to shear/friction, or stable against other stimuli likely to be present during additive manufacturing.

The composition of the fuel material and/or the binder material can depend on the process used to fabricate the solid propellant material in the fuel grain assembly, e.g., additive manufacturing or casting (discussed below). When the solid propellant material is formed by casting, the binder materials can be binder materials that are commonly used in conventional solid propellant formulations, such as HTPB (hydroxyl-terminated polybutadiene), PBAN (polybutadiene acrylonitrile), CTPB (carboxyl-terminated polybutadiene), or other suitable binder materials. When the solid propellant material is formed by additive manufacturing, such as fused deposition modeling additive manufacturing, various types of thermoplastic polymers that are typically used in additive manufacturing processes can be used as the binder material, such as ABS (acrylonitrile butadiene styrene, PLA (polylactic acid), PMMA (polymethyl methacrylate), or other suitable thermoplastics. In some examples, the binder material can be a lower melting point thermoplastic, such as PCL (polycaprolactone), EVA (ethylene vinyl acetate), thermoplastic elastomers (TPE) such as thermoplastic polyurethane (TPU), or other suitable low melting point thermoplastics. Use of a lower melting point thermoplastic can improve safety by providing a larger margin between processing temperature and ignition temperature of the propellant formulation of the solid fuel material. In some examples, other lower melting point materials can be used as the binder material, such as sugar based materials such as sorbitol, sucrose, or dextrose. In some examples, the binder material can be an ultraviolet light curable resin.

The solid fuel additive can be a solid fuel material that is commonly used in conventional solid propellant formulations, e.g., metallic fuel additives such as aluminum powder. Other additives can also be used, e.g., burn rate modifiers, processing aids, or other suitable additives. The additives can be materials that have decomposition temperatures above a processing or forming temperature of the solid propellant material, and that, when added, do not result in the propellant ignition temperature falling below the forming temperature of the solid propellant material. For instance, this decomposition temperature criterion for the additive can be relevant when additive manufacturing is used to form the solid propellant material.

In some examples the binder material serves as the fuel material, e.g., in place of a solid fuel additive. For instance, a binder material such as HTPB or a thermoset polymer such as PBAN or CTPB can be mixed with a suitable oxidizer, such as ammonium perchlorate, resulting in a mixture that can sustain combustion without the use of a solid fuel additive.

Example solid propellant materials have compositions, e.g., containing 15-25% by weight thermoplastic polymer binder, 10-20% solid fuel additive such as aluminum, and 65-75% solid oxidizer. In a specific example, a solid propellant material suitable for deposition by additive manufacturing contains 20% thermoplastic polyurethane binder (e.g., Pearlstick™ 5703, Lubrizol, Brecksville, OH), 15% H2 aluminum solid fuel additive having an average particle size of about 3.5 microns, and 65% potassium perchlorate solid oxidizer.

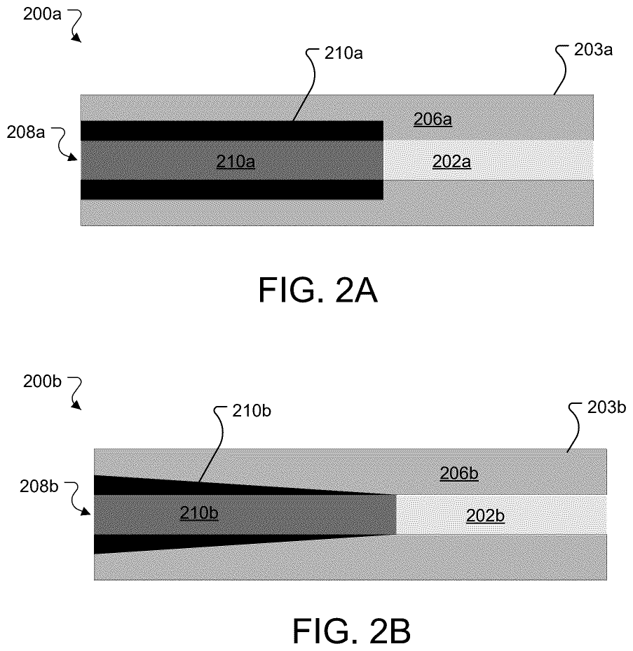

FIGS. 2A and 2B are cross-sectional views of example fuel grain assemblies 200a, 200b (referred to collectively as fuel grains 200) having combustion ports 202a, 202b. The fuel grains 200 include layers 206a, 206b of fuel grain material (referred to collectively as layers 206) forming a hybrid fuel grain 203a, 203b, and solid propellant material 210a, 210b disposed on the innermost layer 206 of the fuel grain 203, e.g., as described for the fuel grain assembly 100 of FIG. 1. In the fuel grain assemblies 200, the solid rocket propellant material is disposed along only a portion of the innermost layer of the fuel grain 203, e.g., only toward the end of the fuel grain assembly where the oxidizer enters the combustion port 202, e.g., adjacent an inlet end 208a, 208b of the combustion port 202. In the fuel grain 200a of FIG. 2A, the solid propellant material 210a is a layer of uniform thickness that extends along a portion of the length of the combustion port 210a. In the fuel grain 200b of FIG. 2B, the solid propellant material 210b extends along a portion of the length of the combustion port 210b with a monotonically decreasing thickness from a maximum thickness at the inlet end 208b of the combustion port 210b.

In some examples, the morphology, e.g., surface roughness, of the solid propellant material is tailored to achieve a target performance. For example, a solid propellant with a higher surface area (e.g., a high surface roughness) can be used to improve ignitability and/or to increase the amount of burning surface, e.g., as compared to a smoother solid propellant. Moreover, a solid propellant with high surface area can produce a high amount of thrust for a short period of time. The morphology of the solid propellant layer can be uniform along the entire combustion port or can vary with location.

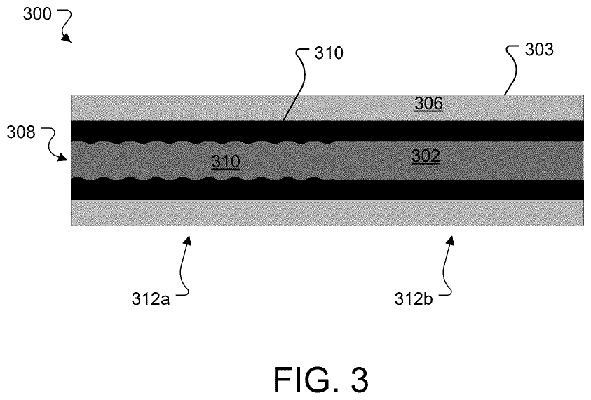

Referring to FIG. 3, an example fuel grain assembly 300 has a combustion port 302, layers 306 of fuel grain material forming a hybrid fuel grain 303, and a solid propellant material 310 disposed along an entirety of an innermost layer of the fuel grain material. The morphology of the solid propellant material 310 varies with location along the combustion port 302. In a first region 312a closest to an inlet end 308 of the combustion port 302, the solid propellant material has a high surface roughness and thus a high surface area. In a second region 312b disposed downstream of the first region 312a, the solid propellant material has a smoother surface, e.g., lower surface roughness and thus lower surface area. In this configuration, the high surface area solid propellant material in the first region 312a ignites and burns quickly, producing flames that propagate downstream to ignite the smoother solid propellant material in the second region 312b. Although FIG. 3 illustrates two regions with different surface morphology, fuel grain assemblies can include more than two regions.

Configurations in which the surface morphology of the solid propellant material varies with location along the combustion port can be relevant for applications in which the solid propellant material is used to produce initial thrust (e.g., as opposed to being used to preheat the fuel grain material). A particular thrust profile can be achieved by tailoring the surface morphology of the regions of solid propellant material.

Other variations in solid propellant material placement can also be implemented. For instance, the solid propellant material can be deposited in discontinuous regions. The solid propellant material can be deposited in patterns such as stripes or checkerboard patterns, e.g., with the pattern being an alternation between solid propellant material of different morphology or between regions where solid propellant material is disposed and regions where no solid propellant material is disposed. Variations in solid propellant material placement can provide more exposed surface area for combustion to occur, e.g., akin to more elaborate port geometries in conventional cast solid rocket motors. Uneven/varying placement of solid propellant material also can allow for tailoring of the engine performance during the initial phase.

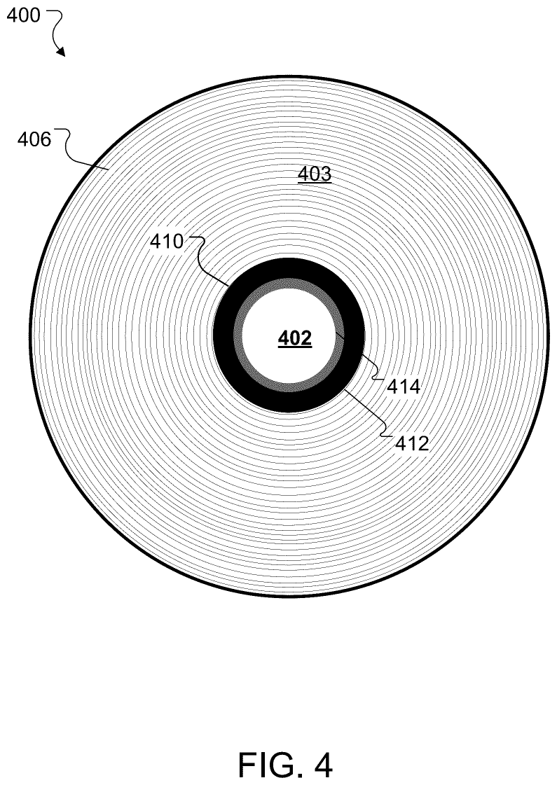

In some examples, the fuel grain assembly can include different compositions of solid propellant material, e.g., multiple layers of different compositions or multiple compositions interspersed with one another. Referring to FIG. 4, an example fuel grain assembly 400 has a combustion port 402, layers 406 of fuel grain material forming a hybrid fuel grain 403, and a solid propellant material structure 410 disposed along an entirety of an innermost layer of the fuel grain 403. The solid propellant material structure 410 includes an outer layer 412 of a first composition of solid propellant material and an inner layer 414 of a second, different composition solid propellant material. The inner layer 414 is exposed to the combustion port 402 and the outer layer 412 is disposed between the inner layer 414 and the innermost layer of the hybrid fuel grain 403.

The performance of the fuel grain assembly, e.g., ignition and/or thrust performance, can be tailored based on the different compositions of solid propellant material in the solid propellant material structure 410. In an example, the inner layer 414 of solid propellant material includes a more energetic and/or faster burning composition than the outer layer 412 of solid propellant material. For instance, the inner layer 414 can include solid propellant material and an energetic additive with higher reactivity or increased sensitivity. In this configuration, the higher reactivity of the composition of the outer layer 412 promotes rapid ignition of the less energetic, slower burning composition of the inner layer 414.

In some examples, the composition of the inner layer 414 is designed to promote ignition of the outer layer 412. In such cases, the sensitivity of the inner layer composition 414 can be tailored such that it has a lower threshold for ignition relative to that of the outer layer 412, e.g., the inner layer can be a “first-fire” composition. The ignition sensitivity of a first-fire composition is generally tailored to strike an appropriate balance between safety (e.g., to prevent unintentional ignition) and ease of ignition such that ignition of successive materials occurs as quickly as possible. Various formulations for first-fire solid propellant compositions are known. One example of such a composition that is suitable for use in the fuel grain assemblies described here is a dry mixture of black powder and a magnesium-aluminum alloy powder, blended together with nitrocellulose lacquer.

In some examples, the composition of the inner layer 414 is intended both to act as a first-fire composition and to produce useful thrust. In such cases, the composition and/or morphology of the solid propellant of the inner layer 414 is designed to increase burning rates, pressure sensitivity, and/or other relevant performance parameters. For instance, such formulations can be relevant to provide a high initial thrust at launch, followed by a reduced thrust as the hybrid rocket engine transitions to hybrid operation. The high thrust phase can be achieved by the morphology (e.g., surface roughness) of the burning surface, composition of the solid propellant material (e.g., addition of burn rate catalysts, varied particle sizes of the constituents, etc.), or formulation of the solid propellant material (e.g., aluminum perchlorate-based propellants offer improved performance compared to potassium perchlorate-based propellants).

In some examples, energetic additives can be nanoscale additives, such as nanoaluminum, e.g., as opposed to micron scale aluminum. Other energetic additives include materials used in explosives, such as RDX, HMX, CL-20, or other suitable materials, in place of certain amounts of the existing propellant constituents. The higher energy density of these additives can improve the energy density of the solid propellant material, but at the cost of higher sensitivity.

Although the outer and inner layers 412, 414 are illustrated as having substantially the same thickness in FIG. 4, the thickness of the two layers can be different. For instance, because the high reactivity of the composition of the inner layer 414 may introduce safety concerns, the composition of the inner layer 414 can be provided in less volume than the composition of the outer layer 412. For instance, the thickness of the inner layer 414 can be less than the thickness of the outer layer 412, and/or the inner layer 414 can be a discontinuous layer.

In the fuel grain assembly of FIG. 4, the outer layer 412 is a continuous layer that is disposed on an entirety of an innermost layer of the hybrid fuel grain 403, and the inner layer 414 is a continuous layer that is disposed on an entirety of the outer layer 412. In some examples, the outer layer 412 and/or the inner layer 414 is a discontinuous layer. In some examples, the outer layer 412 is disposed on only a portion of the innermost layer of the hybrid fuel grain 403. In some examples, the inner layer 414 is disposed on only a portion of the outer layer 412. Additionally, although two layers of solid propellant material are illustrated, the solid propellant material structure 410 can include more than two layers of solid propellant material.

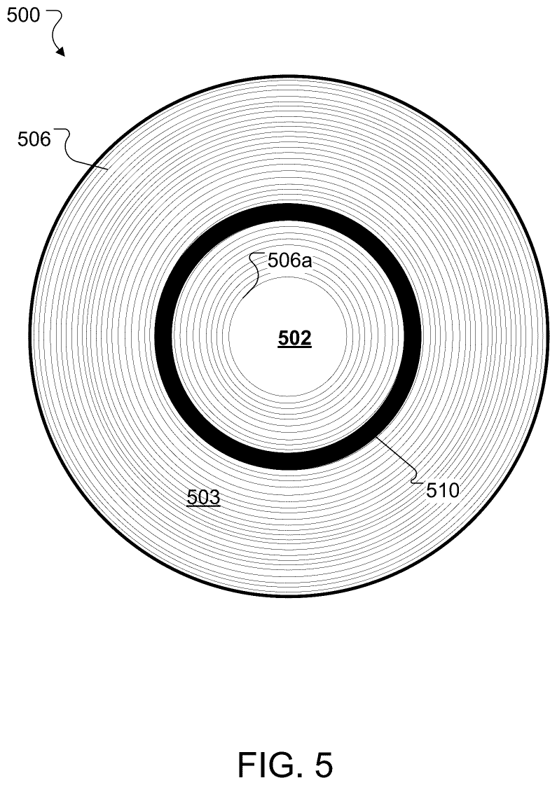

In some examples, a fuel grain assembly includes interior solid propellant material disposed amidst the fuel grain material. FIG. 5 shows an example fuel grain assembly 500 that includes a layer of solid propellant material 510 disposed in the interior of a hybrid fuel grain 503, between and in contact with two layers 506 of fuel grain material. In the example of FIG. 5, a combustion port 502 is defined by an innermost layer 506a of fuel grain material. Some example fuel grain assemblies including interior solid propellant material also include solid propellant material disposed on the innermost layer of the hybrid fuel grain material, e.g., as in the fuel grain assemblies of FIGS. 1-4, such that the combustion port 502 is at least partially defined by the solid propellant material. In the example of FIG. 5, the layer of solid propellant material 510 is a circumferentially continuous layer. In some examples, the interior solid propellant material extends around only a portion of the circumference. The interior solid propellant material can extend along the entire length of the fuel grain assembly or along only a portion of the length, e.g., the interior solid propellant material can be disposed toward an inlet end of the fuel grain assembly.

Fuel grain assemblies having interior solid propellant material can be designed to allow the combustion port geometry to be shifted at set stages during operation. For instance, interior solid propellant material will burn away rapidly. Non-uniform placement of the interior solid propellant material thus will form pockets or grooves in certain areas the next layer of hybrid fuel grain material, thereby generating a combustion port having greater surface area. For instance, by positioning the interior solid propellant material at certain locations along the length of the fuel grain assembly and around its circumference, the areas where the pockets or grooves are formed can be selected, and thus the shape of the combustion port can be engineered.

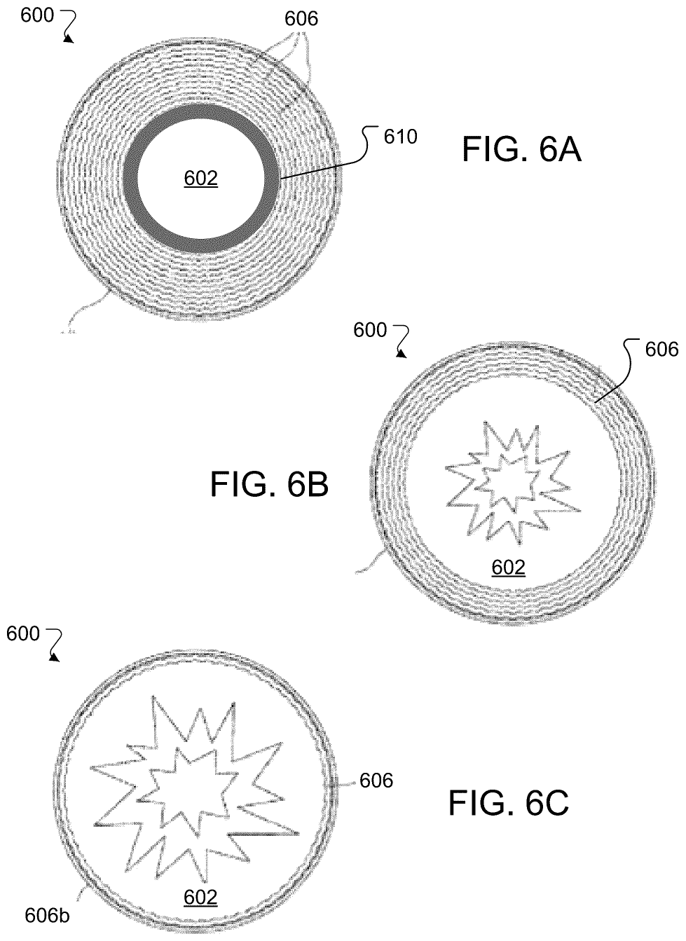

FIGS. 6A-6C show axial cross-sectional views of a fuel grain assembly 600 (shown in axial cross section) at different phases of the flight envelope. The fuel grain assembly 600 has a combustion port 602, layers 606 of fuel grain material forming a hybrid fuel grain, and a solid propellant material 610 disposed along an innermost layer of the hybrid fuel grain, e.g., consistent with the fuel grain assemblies described above.

Referring specifically to FIG. 6A, when an initial ignition source is provided, e.g., an E-match, resistive wire, or other suitable ignition source, the solid propellant material 610 ignites. The operation of the fuel grain assembly 600 after ignition of the solid propellant material 610 depends on the timing for initiation of oxidizer flow in the combustion port 602.

In some examples, once the solid propellant material 610 ignites, it functions as a conventional solid rocket motor until it burns out, at which point oxidizer begins flowing in the combustion port 602. Residual thermal energy in the system as well as any combustion products remaining in the combustion port 602 promote ignition of the fuel grain material 606 for operation as a hybrid.

In some examples, once the solid propellant material 610 ignites, the oxidizer begins flowing in the combustion port 602 after a delay, while the solid propellant material 610 is still burning. This mode of operation promotes a smooth transition from operation as a solid rocket motor to operation as a hybrid. The length of the delay can be tailored to be both long enough that there is sufficient energy in the system to offset the sudden rush of cooler oxidizer and short enough to avoid unnecessary extension of the start-up transient (solid rocket motor operation) state.

In some examples, the oxidizer begins flowing in the combustion port 602 substantially simultaneously with ignition of the solid propellant material 610.

In some examples, when the solid propellant material 610 includes an outer layer and an inner, more energetic layer (e.g., as discussed above for FIG. 4), operation of the fuel grain assembly begins with flow of oxidizer into the combustion port 602. The oxidizer contacts the inner layer of the solid propellant material, which reacts with the oxidizer and acts as an ignition layer to facilitate ignition of the outer layer and the fuel grain material.

In some examples, e.g., depending on the oxidizer, an inner layer of a multi-layer solid propellant material structure is doped with a material that is catalytic with the liquid oxidizer. The catalytic material can be, e.g., a burn rate catalyst specific to the solid propellant itself (e.g., independent of a liquid oxidizer) and/or a catalytic material that interacts specifically with the liquid oxidizer.

For instance, the use of a catalytic material is relevant when nitrous oxide is the oxidizer, in which case the catalytic material is a material intended to promote decomposition of the nitrous oxide to promote further heat release and formation of oxygen gas to promote ignition and/or combustion of the underlying fuel material.

In some examples, when using a hypergolic oxidizer such as hydrogen peroxide, white/red fuming nitric acid, or nitrogen tetroxide, the inner layer is doped with a fuel that is sufficiently reactant with the oxidizer to promote hypergolic ignition. Once this fuel is consumed, combustion continues as a hybrid rocket engine. The material intended to ignite via hypergolic reactions can be a solid propellant or a standard fuel with suitable additives.

In some examples, the innermost material (e.g., defining the combustion port) is a fuel, with or without an underlying layer of solid propellant material. With solid propellant material underlying the fuel, the innermost fuel can be a less sensitive material that would improve system safety, because ignition would not occur until flow of the oxidizer commenced. This situation is relevant, e.g., when typical liquid hypergolic oxidizers are used (e.g., hypergolic oxidizers used in storable liquid bipropellant-based systems), but configurations in which a hypergolic starting slug is used to ignite the system followed by flow of a more conventional oxidizer such as nitrous oxide are also possible.

Exposure to oxidizer causes combustion of the fuel grain material of the hybrid fuel grain. In some modes of operation (e.g., as illustrated in FIG. 6B), the solid propellant material is consumed entirely prior to combustion of the fuel grain material. In some examples, combustion of the fuel grain material occurs concurrently with burning of the solid propellant material.

Combustion of the fuel grain material occurs initially along the exposed surface of an innermost layer of concentric beads of the hybrid fuel grain. Combustion causes the fuel grain material of that innermost layer to pyrolyze, ablate, and phase change due to gas combustion in the combustion port 602. As the concentric beads of the innermost layer undergo a phase change, the next layer of concentric beads is exposed to the combustion port 602 (see FIG. 6C). Each successive layer 606 of concentric beads is exposed to the combustion port 602 until the outermost layer of concentric beads 606b is reached and the hybrid fuel grain is depleted.

In some examples, the layers 606 of concentric beads have a beaded, ribbed texture that presents a large surface area of fuel grain material to the combustion port 602, e.g., a surface area that is greater than the surface area of a similarly sized but untextured (e.g., smooth) surface. Subsequent concentric layers 606 also have a beaded, ribbed texture, such that a large surface area of fuel grain material is continually presented to the combustion port, which contributes to efficient operation of a hybrid rocket engine that includes the fuel grain. In some examples, the layers can have a texture that also induces an eddy current which contributes to efficient combustion by causing the flow of fuel gas further away from the combustion port wall enabling more efficient mixing with the oxidizer gas flowing through the combustion chamber port.

The fuel grain assemblies described here can be manufactured by additive manufacturing techniques, such as fused deposition additive manufacturing. In some examples, both the fuel grain material and the solid propellant material are disposed by additive manufacturing techniques. In some examples, the fuel grain material is disposed by additive manufacturing and the solid propellant material is disposed by casting, painting, or other approaches.

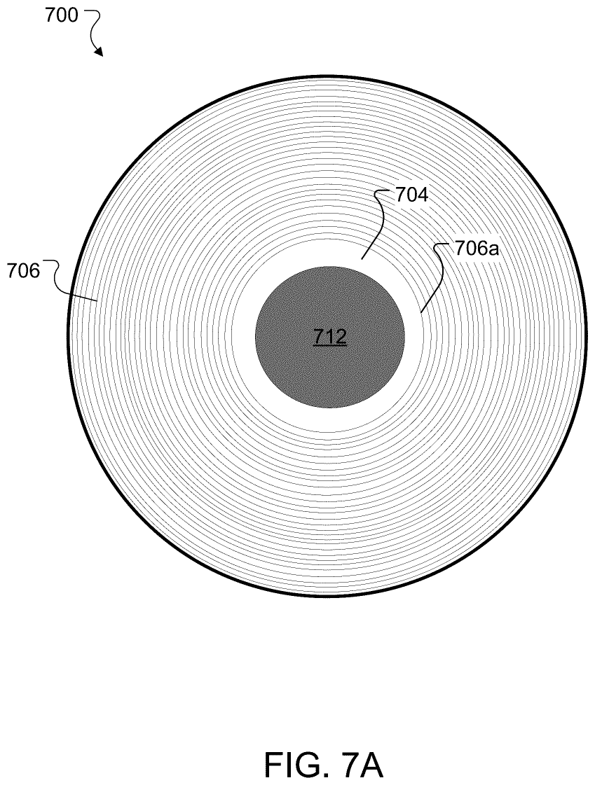

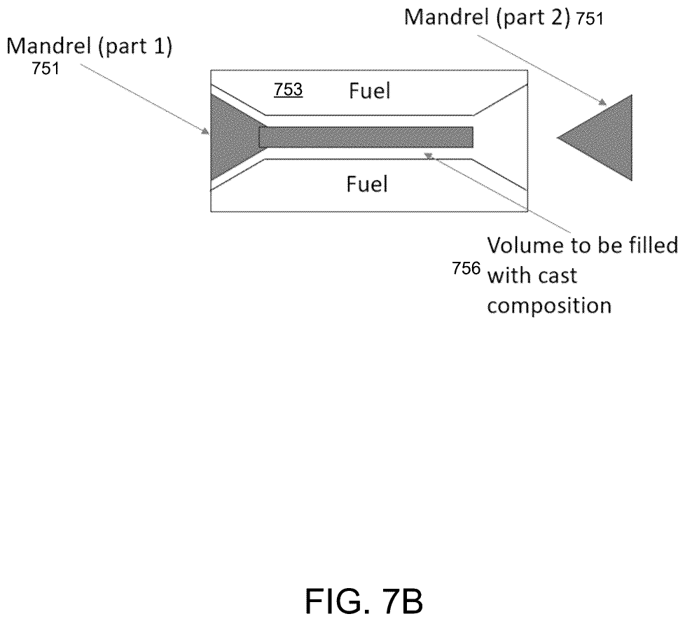

Referring to FIGS. 7A-7B, in some examples, to form a fuel grain, additive manufacturing is used for deposition of layers of fuel grain material to form the hybrid fuel grain, and casting is used for deposition of the solid propellant material. One example is described with respect to FIG. 7A; however, the details of the casting process can depend on the geometry of the fuel grain and of the solid propellant material.

In fused deposition additive manufacturing, the fuel grain material, in a viscous state, is extruded from a deposition head of an additive manufacturing system and deposited as beads, which fuse with adjacent beads and solidify to form a hybrid fuel grain composed of a stacked set of layers, each layer including fused concentric beads. The concentric beads increase in radius from the inner combustion port wall outward. Concentric beads of different compositions are deposited layer by layer by the additive manufacturing system, thereby creating a fuel grain with a variation (e.g., radial, circumferential, or other geometric variation) in the composition of the concentric beads. In some examples, an additive manufacturing system including multiple deposition heads (e.g., two or more deposition heads) is used to deposit the beads, with each deposition head depositing beads of a different composition. In some examples, a single deposition head is used, with the composition of the fuel grain material that is extruded from the deposition head being varied. Other additive manufacturing techniques can also be used, e.g., sintering, photochemical based curing of optically reactive polymers, or other suitable techniques. Description of additive manufacturing deposition of fuel grain material for hybrid rocket engine fuel grains is provided in U.S. Pat. No. 10,286,599, the contents of which are incorporated here by reference in their entirety.

Referring to the axial cross-sectional view of FIG. 7A, after the additive manufacturing fabrication of a hybrid fuel grain 703 composed of layers 706 of fuel grain material, a mandrel 712 is inserted into a combustion port 712 of the hybrid fuel grain 703. The solid propellant material, e.g., as a slurry or in molten form, is poured into a space 704 between the mandrel 712 and an innermost layer 706a of the hybrid fuel grain 703 and allowed to solidify to thereby form a fuel grain assembly. The slurry is generally a viscous composition such that the overall solvent concentration is as low as possible. After casting, the solvent is removed, e.g., by heat, vacuum, or another suitable approach, in some cases while applying mechanical pressure to compact the solid propellant to prevent the formation of voids and/or to remove entrained gases generated by solvent evaporation. In some examples, the solidification involves a curing process. For instance, the propellant casting process can be performed with a curable thermoset resin based formulation (e.g., HTPB). In some examples, the solvent for the slurry is a solvent for the fuel grain material (e.g., for ABS), and the presence of the slurry of the solid propellant material in the space 704 partially dissolves the fuel grain material of the innermost layer 706a, thereby promoting cohesive bonding between the fuel grain material and the solid propellant material.

The approach of FIG. 7A is relevant, e.g., when the fuel grain assembly has a combustion port with a simple geometry, e.g., a cylindrical combustion port, and when the solid propellant material is castable (e.g., melt-castable). When the geometry of the combustion port is more complex, a multi-piece mandrel can be used. For instance, this approach can be relevant for manufacturing a fuel grain assembly having integral pre-and post-combustion chambers as well as a main combustion port such as those illustrated for the fuel grains described above. Referring to FIG. 7B, in this situation, a first mandrel 752 having a geometry corresponding to the combination of one of the pre-or post-combustion chambers and to the main combustion port is inserted from one end of a hybrid fuel grain 753. A second mandrel 751 having a geometry corresponding to the other one of the pre-or post-combustion chambers is inserted from the other end of the hybrid fuel grain 753. The mandrels can be inserted and/or secured using various methods, such as threading, retention pins or clips, or other approaches. Solid propellant material is poured into the spaces 756 between the mandrels 751, 752 and the innermost layers of the hybrid fuel grain 750 and allowed to solidify to thereby form the fuel grain assembly. In some examples, the casting is a single stage of casting following assembly of both mandrels. In some examples, the casting is a multi-stage process in which the first mandrel is inserted and the solid propellant material is cast into the space between the first mandrel and the hybrid fuel grain, and then the second mandrel is inserted and the solid propellant material is cast into the space between the second mandrel and the hybrid fuel grain. The mandrel can be disassembled and removed, or can be removed in another way, such as by chemically dissolving the mandrel.

To form a solid propellant material having a non-uniform thickness, a suitably shaped mandrel can be used, e.g., a mandrel that defines a space of varying width between the mandrel and the innermost layer of the hybrid fuel grain.

To form a solid propellant material structure having multiple layers, multiple rounds of casting, using mandrels with increasingly small diameters, can be used to cast successive layers of solid propellant material.

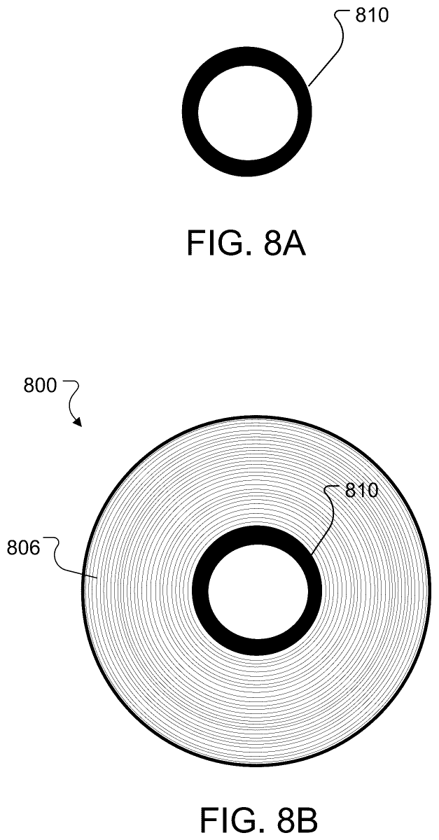

Referring to FIGS. 8A-8B, in some examples, additive manufacturing is used to deposit both the fuel grain material and the solid propellant material of a fuel grain assembly. FIGS. 8A and 8B are axial cross sectional views of a process of additively manufacturing a fuel grain assembly. Referring to FIG. 8A, in a first deposition phase, solid propellant material 810 is disposed into a desired shape, e.g., an elongated cylinder, in an additive manufacturing process. In some examples, one or more layers of concentric beads of solid propellant material are disposed onto a mandrel. In some examples, beads of solid propellant material are extruded without use of a mandrel, e.g., by disposing a vertical stack of beads to form a cylinder shape. Referring to FIG. 8B, after deposition of the solid propellant material 810, layers 806 of fuel grain material are disposed onto the solid propellant material in an additive manufacturing process. When the solid propellant material is disposed to define only a portion of the wall of the combustion port, less than a complete layer of solid propellant material is disposed, and when the fuel grain material is disposed, some of the fuel grain material is disposed onto the solid propellant material and some of the fuel grain material is disposed in regions without solid propellant material.

The process parameters of the additive manufacturing tool are set such that the solid propellant material is flowable but does not ignite. For instance, the processing temperature at which the solid propellant material is printed, extruded, or otherwise deposited is set to provide a safe margin between the processing temperature and the ignition temperature of the components of the solid propellant material and between the processing temperature and the decomposition temperature of the components of the solid propellant material. Additionally, the processing temperature for the deposition of the fuel grain material onto the solid propellant material is also set to provide a sufficient margin of safety. In some examples, the composition of the binder material, oxidizer, and any additives is selected to enable this temperature differential to be achieved.

To form a solid propellant material having a non-uniform thickness, beads of solid propellant material having different sizes and/or different numbers of layers of solid propellant material are disposed at different locations. In some examples, to form a solid propellant material structure having multiple layers, multiple rounds of deposition are performed using different materials as appropriate to form the solid propellant material structure. For instance, a first layer of highly energetic solid propellant material can be deposed directly to form an ignition layer, and one or more subsequent layers of less energetic solid propellant material are disposed onto the first layer. In some examples, the thickness of the solid propellant material can be varied by alternating deposition of solid propellant beads with solid fuel grain material beads, e.g., with a progressive variation in the relative number of each kind of beads to achieve a progressively thinner or thicker layer of solid propellant material. In some examples, additive manufacturing process parameters, such as nozzle size, number of extruders, and/or print layer height, can be varied to achieve a target surface roughness for the layer(s) of solid propellant material.

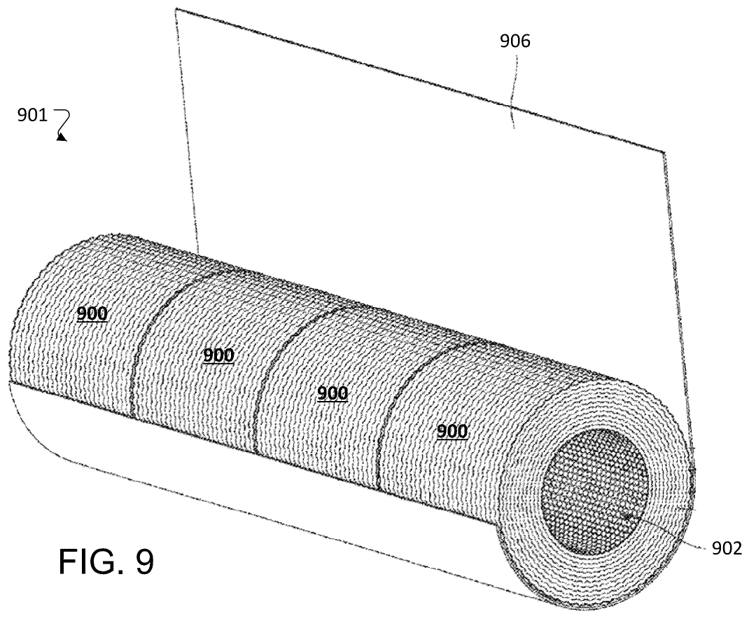

Referring to FIG. 9, in some examples, individual fuel grain assemblies 900 are assembled into a fuel grain set 901, e.g., by fusion bonding. The individual fuel grain assemblies 900 can be any of the fuel grain assemblies described above. A set 901 of multiple fuel grain assemblies 900 is useful, e.g., to provide a fuel grain set capable of producing more thrust than is possible from an individual fuel grain. A set of multiple fuel grain assemblies can also be useful, e.g., to construct a fuel grain assembly of a desired size that is larger than the capacity of an additive manufacturing system used for fabrication of the assemblies.

An end of each of the individual fuel grain assemblies 900 is bonded to an end of an adjacent fuel grain assembly. The resulting fuel grain set 901 is an elongated structure with a combustion port 902 extending axially through the entire length of the fuel grain set. In some examples, each of the fuel grain assemblies 900 in the fuel grain set 901 has the same composition, e.g., the same composition of fuel grain material and composition/geometry of solid propellant material. In some examples, one or more of the fuel grain assemblies has a different composition than the other fuel grain assemblies, e.g., with different compositions, amounts, or morphologies of solid propellant material.

In some examples, a connector (not shown) extends from the end of one fuel grain assembly and mates with a cavity at the end of an adjacent fuel grain assembly to secure the fuel grain assemblies together in the fuel grain set 901. In some examples, polymer based rocket fuel material (e.g., ABS) is heated to above its glass transition temperature but below the ignition temperature of the micron-scale or nanoscale metallic material and applied (e.g., by spraying or spreading) to the ends of adjacent fuel grain assemblies. Upon cooling, the material creates a strong bond between the fuel grain assemblies to secure the fuel grain assemblies together in the fuel grain set 901. In some examples, the fuel grain assemblies are secured together through use of solvents appropriate to a given polymer. For fuel grain assemblies formed of ABS can be bonded together by applying acetone to the mating surfaces, allowing for local softening and/or dissolving of the ABS material and thereby the formation of cohesive bonds between adjacent assemblies upon removal of the solvent.

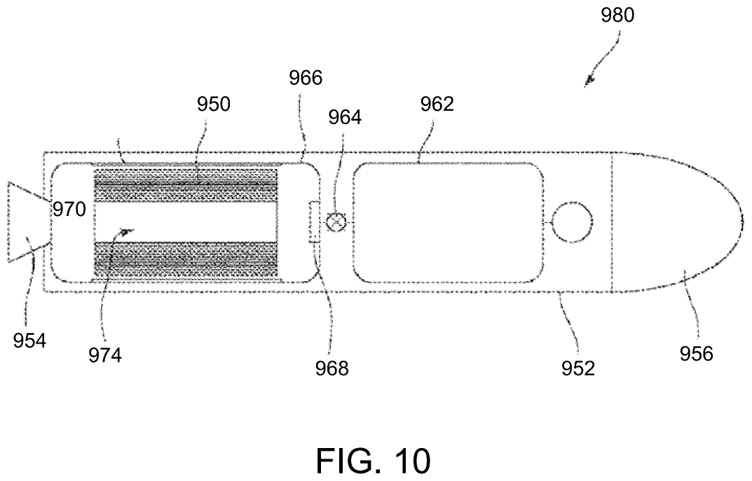

The fuel grain set 901 is encased in an outer cover 906, e.g., carbon fiber filament or carbon fiber tape, to provide structural reinforcement to the fuel grain set 901. In some examples, the fuel grain set 901 is also wrapped in a thermally protective cover. In other examples, the wrapping provides both thermal protection and structural reinforcement. In still another example, the cover is in the form of a tube in which the fuel grain set is inserted for a tight fit. Once encased in the cover(s), the fuel grain set 901 can be placed into an engine case of a rocket (see FIG. 10). In some examples, the wrapping or tube serves as the engine case.

Referring to FIG. 10, an example hybrid rocket engine powered vehicle 980 incorporates a wrapped fuel grain assembly 950 (e.g., any of the fuel grain assemblies or the fuel grain set described above). In some examples, a fuel grain set of multiple fuel grain assemblies is used in place of a single fuel assembly. The hybrid rocket engine powered vehicle 980 includes a body 952, a nozzle 954 at one end of the body 952, and a payload section 956 at the other end of the body 952. The body 952 houses a hybrid rocket engine 960 that includes an oxidizer tank 962, a valve 964, an engine case 966, and an oxidizer injector 968. The oxidizer injector 968 is housed within a forward cap (not shown) that also houses an ignition system (not shown). The engine case 966 houses a pre-combustion chamber (not shown), a post-combustion chamber 970, and the fuel grain 950 wrapped in a cover or inserted within a tube. Oxidizer from the oxidizer tank 962 is injected into a combustion port 974 of the fuel grain assembly 950, where successive regions of varying composition are exposed to and combusts with the oxidizer, providing the hybrid rocket engine with a thrust and economy composition suited to the flight profile of the hybrid rocket engine powered vehicle 980.

Particular embodiments of the subject matter have been described. Other embodiments are within the scope of the following claims.

What is claimed is:

1. A fuel grain assembly for a hybrid rocket engine, the fuel grain assembly comprising:
a hybrid fuel grain comprising fuel grain material, wherein an outermost portion of the fuel grain material defines an outer surface of the fuel grain, and wherein the fuel grain material comprises a polymer based rocket fuel material; and
a solid propellant material disposed in contact with the fuel grain material of the hybrid fuel grain, wherein the solid propellant material comprises an oxidizer and a binder material,
wherein a hollow combustion port extends through the fuel grain assembly, wherein at least a portion of a wall of the hollow combustion port is defined by the solid propellant material.

2. The fuel grain assembly of claim 1, wherein the hybrid fuel grain comprises multiple layers of fuel grain material, and wherein the outermost portion of the fuel grain material defining the outer surface of the fuel grain comprises an outermost layer of the fuel grain material.

3. The fuel grain assembly of claim 2, wherein the solid propellant material is disposed on an innermost layer of the hybrid fuel grain.

4. The fuel grain assembly of claim 2, wherein the solid propellant material is disposed between two layers of fuel grain material of the hybrid fuel grain.

5. The fuel grain assembly of claim 1, wherein the solid propellant material is a continuous layer of the solid propellant material.

6. The fuel grain assembly of claim 1, wherein the solid propellant material defines the entirety of the wall of the hollow combustion port.

7. The fuel grain assembly of claim 1, wherein the solid propellant material is disposed on less than all of an innermost surface of the fuel grain, and wherein the wall of the combustion port is defined by the solid propellant material and by portions of the innermost surface of the fuel grain.

8. The fuel grain assembly of claim 7, wherein the solid propellant material is disposed is adjacent an inlet end of the combustion port.

9. The fuel grain assembly of claim 1, wherein a thickness or a surface roughness of the solid propellant material is non-uniform.

10. The fuel grain assembly of claim 1, wherein the solid propellant material comprises an inner layer and an outer layer, wherein the inner layer is exposed to the combustion port, and wherein the inner layer has a more energetic composition than the outer layer.

11. The fuel grain assembly of claim 1, wherein the solid propellant layer is doped with a material that is catalytic with an oxidizer.

12. The fuel grain assembly of claim 1, wherein the binder material comprises a thermoset or thermoplastic binder material.

13. The fuel grain assembly of claim 1, wherein the binder material comprises a solid fuel additive.

14. The fuel grain assembly of claim 1, wherein the solid propellant material has an ignition temperature that is higher than a temperature used during deposition of the solid propellant material.

15. The fuel grain assembly of claim 1, wherein the solid propellant material comprises a metallic fuel additive that has a decomposition temperature that is higher than a forming temperature of the solid propellant material.

16. The fuel grain assembly of claim 15, wherein the solid propellant material containing the additive has an ignition temperature that is higher than a forming temperature of the solid propellant material.

17. A method of making a fuel grain assembly, comprising:
using an additive manufacturing tool, disposing a solid propellant material to form a layer of solid propellant material, wherein the solid propellant material comprises an oxidizer and a binder material; and
using the additive manufacturing tool, disposing fuel grain material in contact with the solid propellant material to form a fuel grain comprising layers of the fuel grain material, wherein the fuel grain material comprises a polymer based rocket fuel material,
wherein the solid propellant material defines at least a portion of a wall of a hollow combustion port extending through the fuel grain.

18. The method of claim 17, comprising disposing the solid propellant material and the fuel grain material such that the wall of the combustion port is defined in part by the solid propellant material and in part by the second portion of the fuel grain material.

19. The method of claim 17, comprising disposing the solid propellant material at a temperature that is lower than an ignition temperature of the solid propellant material.

20. The method of claim 17, comprising disposing the solid propellant material in different thicknesses at different locations.

21. The method of claim 17, wherein disposing the solid propellant material comprises:
disposing an inner layer of solid propellant material; and
disposing an outer layer of solid propellant material onto the inner layer, wherein the inner layer has a more energetic composition than the outer layer, and wherein the fuel grain material is disposed onto the outer layer.

22. The method of claim 17, comprising disposing the fuel grain material at a temperature that is less than a temperature of an ignition temperature of the solid propellant material.

23. A method of making a fuel grain assembly, comprising:
using an additive manufacturing tool, disposing beads of fuel grain material to form a hybrid fuel grain comprising layers of fuel grain material with a hollow combustion port extending therethrough, wherein the fuel grain material comprises a polymer based rocket fuel material; and
disposing a solid propellant material in contact with an innermost layer of the hybrid fuel grain such that at least a portion of a wall of the hollow combustion port is defined by the solid propellant material, wherein the solid propellant material comprises an oxidizer and a binder material.

24. The method of claim 23, wherein disposing the solid propellant material comprises casting the solid propellant material onto the innermost layer of the hybrid fuel grain.

25. The method of claim 23, wherein disposing the solid propellant material comprises disposing a precursor formulation onto the innermost layer of the hybrid fuel grain and curing the precursor formulation to form the solid propellant material.

26. The method of claim 23, comprising disposing the solid propellant material at a temperature that is lower than an ignition temperature of the solid propellant material.

27. The method of claim 23, comprising disposing the solid propellant material using additive manufacturing.

28. The method of claim 23, wherein depositing the solid propellant material comprises:
disposing a slurry containing the solid propellant material and a solvent onto the innermost layer of the fuel grain material; and
drying the slurry.

29. A method of making a fuel grain assembly for a hybrid rocket engine, the method comprising:
forming a hybrid fuel grain comprising fuel grain material, wherein an outermost portion of the fuel grain material defines an outer surface of the fuel grain, and wherein the fuel grain material comprises a polymer based rocket fuel material; and
disposing a solid propellant material in contact with the fuel grain material of the hybrid fuel grain, wherein the solid propellant material comprises an oxidizer and a binder material,
wherein a hollow combustion port extends through the fuel grain assembly, wherein at least a portion of a wall of the hollow combustion port is defined by the solid propellant material.

30. The method of claim 29, comprising forming the hybrid fuel grain by additive manufacturing.

31. The method of claim 29, comprising forming the hybrid fuel grain by casting.

32. The method of claim 29, comprising disposing the solid propellant material by additive manufacturing.

33. The method of claim 29, comprising disposing the solid propellant material by casting.
